(19) United States
(12) Patent Application Publication
(10) Pub. No.: US 2007/0071785 A1
(43) Pub. Date: Mar. 29, 2007

(54) Solid stick insecticidal composition

(75) Inventors: Daniel Jeremy Craven, West Ryde (AU); Andrew Martin Scrivener, West Ryde (AU); Graeme Bruce Smith, West Ryde (AU)

Correspondence Address: MERCHANT & GOULD PC, P.O. BOX 2903, MINNEAPOLIS, MN, 55402-0903, US

(73) Assignee: Reckitt Benckiser (Australia) Pty Limited, West Ryde, NSW (AU)

(21) Appl. No.: 10/570,056

(22) PCT Filed: Aug. 26, 2004
(86) PCT No.: PCT/GB04/03658

§ 371 Date: Dec. 12, 2006

(30) Foreign Application Priority Data
Aug. 29, 2003 (GB) 0320240.5

(51) Int. Cl. A01N 65/00; A01N 57/00; A01N 43/56; A01N 25/08; A01N 43/04; A01N 55/08; A01N 43/40; A01N 47/10; A01N 47/28; A01N 41/06; A01N 33/26

(52) U.S. Cl. 424/410; 514/28; 514/65; 514/114; 514/406; 514/602; 514/340; 514/64; 514/479; 514/594; 514/639

(57) ABSTRACT

A solid sick insecticidal composition comprising a base, an insecticide and at least 60 wt % food material. The stick may be used to deposit insecticide composition onto a hard surface for controlling crawling insects.

### TECHNICAL FIELD

The present invention relates to insecticidal compositions, and more specifically to both novel forms of insecticidal compositions and methods of controlling crawling pests such as cockroaches.

### BACKGROUND DISCUSSION AND PRIOR ART

Insects such as cockroaches and ants are a continual problem in both domestic, commercial and industrial establishments. They are difficult to control, finding harbourage in a multitude of locations including behind and under cabinets, appliances, sinks and worktops and in cupboards. Furthermore, they can readily move to a new home when a harbourage becomes unacceptable.

Conventional methods for controlling such pests include aerosol sprays and baits. However, each of these methods has disadvantages. Aerosol products do not generally have a long residual activity and the spray tends to radiate widely, going onto surfaces where protection is not sought or where the active ingredient is not wanted. In addition, aerosol propellants tend to be flammable.

Bait compositions come in a variety of forms including tablets, pastes, gels and other semi-solid preparations. Bait compositions are frequently held in a container or housing that only allows insect access. This means that baits cannot be placed in many areas where the insects might walk or find harbourage, such as around the periphery of cabinet doors, on the undersides of worktops, or along junctions.

U.S. Pat. No. 3,162,575 (Lang) discloses an insecticide stick for flies having 40-80% microcrystalline wax base mixed with 10-60% petroleum oil, up to 50% particulate sugar and 0.25-1.5 dimethyl-dichloro-vinyl-phosphate (DDVP) insecticide. The insecticide is applied to the faces of domestic livestock by rubbing, preferably between the eyes. The sugar reportedly causes the flies to be drawn toward the area of the face which is coated with the active ingredient.

U.S. Pat. No. 3,826,232 (Duffey et al.) discloses a pest control stick for application to the neck or face of domestic animals to control fleas, lice, ticks, flies and the like. The stick comprises 0-(2-isopropoxyphenyl)-N-methyl carbamate as the active insecticide, fatty acid, fatty alcohol, polyethylene glycol and, preferably, a bitter tasting compound which serves to discourage licking by other animals and tasting by children.

U.S. Pat. No. 4,473,582 (Greene) discloses an insecticidal stick for application to a household surface or domestic animals. The sticks comprise 0.25-5 wt % water-insoluble insecticide, 10-65 wt % fatty hydrocarbon monoether or propylene glycol and 30-70 wt % monoethanolamide of a fatty acid. When applied to a household surface, the stick reportedly deposits a thin film of the stick formulation on the surface and insects, such as cockroaches, walking or crawling over the film, it is believed, ingest or absorb the insecticide through their cuticles.

GB 608,715 (Ash Laboratories Limited) discloses solid insect control materials formed by compacting and subsequently drying a mixture of active insecticide, a liquid and a solid diluent or filler. The mixture may also contain a waxy or fatty substance so as to form a waxy crayon-like solid.

The solid insecticidal sticks described in the prior art address only some of the problems associated with the use of conventional pest control methods. Hence, there is still a clear need for improved compositions and methods for controlling pests, especially crawling insects such as cockroaches.

### SUMMARY OF THE INVENTION

Accordingly, this invention provides a solid stick insecticidal composition comprising a base, an insecticide and at least 60 wt % of a food material.

This invention also provides a method for controlling insects in which a solid stick composition comprising an insecticide and at least 60 wt % of food material is applied to a hard surface to be treated.

Furthermore, this invention provides an insect control product comprising a solid stick insecticidal composition according to the invention which is packaged.

In addition, this invention provides for use of an insecticide and a food material in the manufacture a solid stick insecticidal composition for application to a hard surface to be treated.

The compositions and methods of pest control of the present invention are highly effective against crawling insects and provide significant improvements over the insecticidal sticks of the prior art. In particular, the compositions of the present invention provide significant advantages over known stick compositions when applied to hard surfaces. The high percentage of food material in the stick compositions results in the majority of the deposited material being ingested by insects, such as cockroaches, thus leaving little or no material to be cleared away. In contrast, the prior art sticks have a tendency to remain in situ once deposited and have to the cleaned up. The insecticidal sticks of the present invention are therefore considerably easier and more convenient to use than those described previously. Furthermore, less material is required to be deposited to obtain equivalent levels of pest control, e.g. kill rates. The insecticidal sticks of the present invention are also stable and possess a long residual activity.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed before the priority date of each claim of this application.

### DETAILED DESCRIPTION OF THE INVENTION

As used herein, all figures given as % wt are, unless specified otherwise, the percentage by weight of that component relative to the total weight of the solid stick insecticidal composition. Where a set of parameter ranges are given for a particular component or composition, it will be understood that any lower limit in that set of ranges may be combined with any upper limit in the same set of ranges to provide a suitable range limit for that component or composition.

Where an ingredient can perform more than one function, for example act as both a food material component and as part of the base composition, it will be understood that, unless specifically indicated otherwise, it can contribute to the stated weight ranges relating to both functions equally.

The compositions of the present invention comprise at least one insecticide component. Suitable insecticides may be chosen from a wide range of active ingredients, both natural and synthetic.

Examples of suitable insecticide ingredients include pyrethroids, neonicotinoids (e.g. imidacloprid, thiamethoxam), avermectins, spinosyns (e.g. spinosad), hydramethylnon, fluorinated sulfluoramides, organophosphates including diazinon and chlorpyrifos, pyrazoles such as fipronil, chlorfenapyr, indoxacarb, borates, benzoylphenyl ureas, carbamates and hydrazones. Preferred insecticides includeorganophosphates, such as chlorpyrifos, pyrazoles, such as fipronil, and indoxacarb.

One or more insecticides may be employed. In addition, insecticide(s) may be micro-encapsulated, non-encapsulated or a combination of the two. For example, a combination of non-encapsulated and microencapsulated chlorpyrifos may be used. The particular choice of insecticide(s) depends on several factors including the target insect(s), the strategy for killing the insects, the regulatory approval status in a particular country, cost, etc. As regards the strategy for killing insects, insecticides can act in a variety of ways. For example, some insecticides directly kill the insects, some affect the fecundity of the insect such that the insect population is reduced in subsequent generations, and some alter the behaviour of the insect in a manner that will bring about its destruction. In addition, insect populations can also be reduced as a result of transmission of insecticidal composition between insects—this is generally referred to as “secondary kill”.

The total amount of insecticide in the solid stick insecticidal composition will suitably range from 0.01 to 40 wt %, preferably from 0.01 to 20 wt %, more preferably from 0.01 to 10 wt %, yet more preferably from 0.01 to 5 wt %, even more preferably from 0.02 to 5 wt %, yet more preferably from 0.03 to 3 wt % and most preferably from 0.03 to 2 wt %.

Biological control agents, such as the bacterium Bacillus thuringiensis or entomophagous fungi (e.g. Beauveria bassiana) could also potentially be used as ‘active ingredients’ in the present invention. For the purposes of the present invention, any amount of biological control agent present is considered to form part of the insecticide component as regards weight ranges.

The compositions of the present invention comprise at least one food material component.

Examples of suitable food materials include carbohydrates, proteins, lipids, essential oils, water, spices and mixtures thereof. Preferred carbohydrates include honey, sugars (including monosaccharides and disaccharides), oligosaccharides, polysaccharides and other complex carbohydrates such as starches, pectins and cellulosic materials. Examples of suitable starches include those found in flours such as, for example, corn flour and potato flour. Other preferred carbohydrate and/or protein food materials include soya flour, cereal products such as bran and wheat germ, vegetable products, dehydrated vegetables, dried yeast, egg powder and insect derived materials such as silkworm pupa, eggs and body parts.

Other preferred food materials include fats and oils such as fully hydrogenated fatty acids. A preferred oil is soya bean oil. Other fatty materials that may be used include esters, waxes, soaps, phospholipids such as lecithin, glycolipids, terpenes and steroids.

The total amount of food material in the solid stick insecticidal compositions is at least 60 wt %. Suitably, the food material is present in the insecticidal composition in an amount of at least, in the order of preference, 65, 70, 75, 80, 85 and 90 wt % to 99.99 wt %.

Particularly preferred ranges are from 70 to 99.99 wt %, more preferably from 90 to 99.99 wt %.

The insecticide is dispersed within, and the food material either forms part of and/or is dispersed within, a fatty base. The base composition may also have dispersed therein one or more optional components. Preferably, all the components of the stick are uniformly dispersed within the base composition.

The base ingredients contribute to the physical and rheological properties of the stick. Some ingredients may contribute primarily to the physical properties of the stick, i.e. the hardness or rigidity of the stick, some may act primarily as lubricants, some may act primarily as emollients or emulsifiers and some may act primarily as adhesion promoters or binding agents. It may also be beneficial to employ ingredients in the base which act primarily as solvents for certain components, for example certain insecticide components, of the insecticidal stick. A preferred insecticide of the present invention, is chlorpyrifos and this is preferably dissolved in a suitable solvent component of the base composition such as, for example, hydrogenated palm stearine and soya bean oil.

Suitable base ingredients include fatty alcohols, fatty acids, various esters including lower alkyl esters of fatty acids, polyethylene glycols (carbowaxes), monoalkanolamides, castor oil, mineral oils and petroleum jellies. Suitable base materials which contribute to the hardness and rigidity of the sticks are typically materials having higher melting points. Such materials are also important in the moulding process. These materials are typically waxes or wax-like materials and include carnauba wax, candelilla wax, amorphous hydrocarbon waxes, petroleum-based waxes such as microcrystalline wax, beeswax, paraffin waxes, cocoa butter, hydrogenated vegetable oils such as hydrogenated palm stearine and hydrogenated castor oil, lanolin and lanolin absorption bases, some paraffin oils, lecithin and silicone waxes.

Some ingredients can have a dual function as a food material and as a component of the base. Examples of such dual functionality ingredients include hydrogenated palm stearine, tallow, lard, suet and duck fat. In addition, some food materials that are not at all waxy or fatty in nature also act as base ingredients. For example, flours, e.g. soya flour, can act as binding agents and thus effect the rheology of the base composition. In addition, ingredients such as lecithin and monoglycerides can act as emulsifiers, helping to suspend and disperse hydrophilic materials in hydrophobic materials and vice-versa. Preferably, the base composition comprises one or more materials which act as emulsifying agents. Such emulsifying materials are suitably present in amount of from 1 to 10 wt %, preferably from 2 to 8 wt % of the solid stick insecticidal composition.

Preferably, the base comprises at least one of hydrogenated palm stearine, soya flour, lecithin and monoglyceride.

Suitably, the base composition has a melting point in the range from 20 to 200° C., preferably from 35 to 100° C. and more preferably from 40 to 80° C.

The total amount of base ingredients in the solid stick insecticidal composition will suitably be, in order of preference, at least 10, 20, 30 and 40 wt %. Suitably, the total amount of base ingredients in the solid stick insecticidal compositions will be, in order of preference, no more than 99.99, 99, 95, 90, 85, 80, 75 and 70 wt %.

The insecticidal compositions may also comprise one or more optional components such as attractants, preservatives, anti-oxidants, feeding stimulants, fillers, animal (including human) taste deterrents and colorants.

In a preferred embodiment, the insecticidal compositions comprise at least one attractant. Where compositions comprise a food material and an attractant, this may be achieved by using separate food material and attractant components or alternatively by using an ingredient that acts both a food material and an attractant.

Examples of suitable attractants, which attract through smell and/or other neurosensory pathways, include pheromones, yeast extracts, complex foods and volatile materials such as flavour essences and food derivatives including fenugreek, maple lactone, herbs and spices. When insecticides are themselves repellant in nature to insects, an attractant as taught and disclosed in WO 97/00610 (R. & C Products Pty Ltd) may suitably be used. Preferred attractants include maple lactone, soya bean oil, malt extract and honey.

Examples of dual functionality food materials, which also act as attractants, include soya bean oil, spices, yeasts, yeast extracts, malt extracts and maple lactone. The function of each material will of course depend to some extent on the particular species of insects you are looking to treat. For example, soya bean oil, honey, malt extract and maple lactone all act both as food materials and attractants for cockroaches. Preferably, the insecticidal compositions of the present invention comprise maple lactone, which is suitably present in an amount of from 0.001 to 1 wt %, preferably from 0.005 to 0.5 wt % and more preferably from 0.005 to 0.05 wt %.

Suitably, the total amount of attractant in the insecticidal compositions (including any dual functionality components) is at least 0.1, preferably at least 0.5, more preferably at least 1.0 and yet more preferably at least 2 wt %.

In contrast to the prior art stick compositions which are only effective when carefully applied as an unbroken line such that the insects invariably cross the line at some point in their travels, the insecticidal compositions of the present invention can be applied to hard surfaces as “spots” or short lines of material whilst still providing a level of pest control that is at least as equivalent and typically more effective than that described in the prior art. This is particularly the case when the compositions contain an attractant.

A preservative may be present to inhibit the growth of microorganisms on the composition, as such growth may potentially repel insects. Amongst the preservatives that may be used are sorbic acid and salts thereof (e.g. potassium sorbate), Dowicil™ (Dow-Elanco) and methyl- and propylparabens. Suitably, preservatives may be present in an amount from 0.0001 to 10 wt %, preferably from 0.001 to 5 wt %.

Anti-oxidants may be present to maintain food material palatability in an amount of from 0.0001 to 10 wt %, preferably from 0.001 to 5 wt %. Suitably, in compositions that include fats and/or oils, an antioxidant such as tert-butyl hydro-quinone (TBHQ), butylated hydroxytoluene or butylated hydroxyanisole is used. TBHQ is a preferred anti-oxidant in insecticidal sticks of the present invention.

Animal taste deterrents may be included to minimise the risk of accidental consumption. Suitable human deterrents include denatonium benzoate (Bitrex™ MSL). When present, a human taste deterrent is suitably used in an amount of from 1 to 200 ppm, preferably from 1 to 100 ppm, more preferably from 10 to 50 ppm and most preferably from 5 to 20 ppm.

The sticks may be coloured by including one or more colorants in the formulation. Suitable colorants include, for example, many of the conventional food dyes, e.g. carmoisine. Suitably, a colorant may be present in an amount of up to 1 wt %, preferably from 0.0005 to 0.5 wt %, more preferably from 0.0005 to 0.2 wt % and yet more preferably from 0.0005 to 0.05 wt %.

The sticks of the present invention leave a deposit of composition on a hard surface when applied to the hard surface. The sticks should not bend, crumble, crack or break during application. The physical properties and quality of the stick during manufacture, storage and use are determined for the most part by the composition of the fatty base composition. These properties and qualities are largely related to the rheology of the mixture at various temperatures. For example, during manufacture (usually while warm), it is preferably possible to mix or mill the formulation and to pour and mould it whilst holding any insoluble components evenly dispersed without settling. During shelf life and the life of usage, the stick should remain rigid and stable. In use, the stick must be capable of depositing composition onto hard surfaces on application of a downward force. The hard surfaces may, for example, be tiles, concrete, wood, stone, metal, glass or plastics such as melamine. It will be understood that hardness and deposition properties of the solid insecticidal sticks will vary somewhat depending on the composition, and in particularly the base composition. The stick may be relatively hard and akin to a conventional drawing crayon. In such cases, the stick may have to be drawn across, rubbed onto or, where spot deposition is required, twisted onto the hard surface in order to deposit insecticidal composition. Alternatively, the stick may be “softer” and more akin to a lipstick. Clearly more force is ordinarily required to deposit a drawing crayon than a lipstick onto a hard surface. Softer compositions will also tend to deposit smears of material. It will also be evident that depending on the nature of the surface to be treated, different formulations may be preferred in order to achieve satisfactory deposition. A crayon-like stick will readily deposit on rough surfaces such as concrete whereas it may have difficulties depositing on shiny surfaces such as stainless steel or polished stone, where a softer more adherent formulation may be more appropriate.

The deposited composition suitably adheres to the hard surface, i.e. once applied to the surface, and remains more or less in place until ingested by insects or physically wiped or scraped off. Suitably the compositions do not dry out to any significant degree after application (at least over a period of a day, and preferably for longer) and the deposited material remains in a form which allows it to be ingested by the target insects and therefore-does not harden to a point where it is unpalatable. In this way, insects are encouraged to approach the deposited composition and/or remain with the deposited composition for a period of time.

The solid sticks of the present invention suitably have the outward appearance of a cylinder, rod or crayon. The sticks may be any suitable shape in cross section including circular or a polygon of three or more sides. A preferred shape is circular. The sticks may be tapered at one or both ends, preferably one end.

The sticks are typically of a size suitable for holding in the hand so as to allow the easy drawing of lines or spots on hard surfaces. Suitably, the sticks are from 10 to 300 mm in length, preferably from 30 to 200 mm, and more preferably from 50 to 120 mm. Suitably, the average cross-sectional area of the stick is from 20 to 2,000 mm², preferably from 40 to 500=2 and more preferably from 60 to 200 mm².

The hardness of the stick should be such that the crayon can be held near the surface to be treated and pressed onto and dragged across that surface with a moderate amount of force without breaking. At the same time it should be capable of depositing a sufficient quantity of material for insects such as cockroaches to ingest a lethal dose.

The hardness and rigidity of the solid stick compositions may be determined by penetrometry. Suitable procedures are described in ASTM D1321; IP376; DIN 51579. For example, hardness may be measured using a lab plant PNT penetrometer equipped with a Seta wax needle (weight 2.5 grams) which has a cone angle at the point of the needle specified to be 9°10′+/−15′. The barrel of the stick is cut to leave a flat uniform surface. The needle is lowered onto the surface of the composition and then a penetration hardness measurement is conducted by allowing the needle with its holder to drop under a total weight, (ie. the combined weight of needle and holder) of 50 grams for a period of five seconds after which the depth of penetration is noted. Desirably the test is carried out at a number of points, e.g. six points, on each sample and the results are averaged.

Utilising a test of this nature, the solid insecticidal compositions of the present invention suitably have a penetration hardness of from 0.1 to 10 mm, preferably from 0.5 to 8 mm, more preferably from 1 to 5 mm, yet more preferably from 1 to 4 mm and even more preferably from 1 to 3 mm.

The solid stick compositions may also be tested for their ability to deposit onto hard surfaces. For example, a suitable deposition test is to fit a sample of the composition with standardised shape and size to an apparatus which draws the sample across a test surface under standardised conditions. The amount transferred to the surface is then determined as an increase in the weight of the substrate to which it is applied. Suitable test substrates include ceramic tiles, concrete, wood, melamine (laminate), metal and glass.

The substrates are weighed before use. The sticks are previously unused. The apparatus comprises a flat base to which a flat substrate is attached by a clip at each end. A pillar having a mounting to receive a standard size stick is mounted on an arm that is moveable horizontally across the substrate by means of a pneumatic piston. Each stick is kept at ambient laboratory temperature overnight before the measurement is made. The stick is placed in the apparatus and a spring positioned to bias the stick against the substrate with a standardised force. The apparatus is operated to pass the stick laterally across the substrate a set number of times. The substrate is carefully removed from the rig and reweighed.

Such a deposition test may also be used to help assess the quality and nature of the deposition, e.g. the adhesion properties, whether smearing is occurring and stability properties (e.g. drying-out properties).

Insecticidal compositions are often widely used in warm countries. For this reason, it is preferable that the stick compositions of the present invention have a reasonably high melting point. Suitably, the solid stick insecticidal compositions have a melting point of at least 20° C., preferably at least 35° C., more preferably at least 40° C. and even more preferably at least 45° C.

The solid stick insecticidal compositions preferably have a setting point in the range from 20 to 200° C., more preferably from 30 to 70° C. and yet more preferably from 45-55° C.

The stick may be used in an uncovered form. Alternatively, and preferably, the stick may be provided with a packaging. The packaging may cover the entire length of the stick or only part thereof. It may comprise of a protective wrapping (paper, plastic, fabric, metal foil or other suitable material including laminated materials) axially orientated around the stick, which is suitably affixed, e.g. by gluing, along a line of overlap or as a self-adhesive sticker wrapping. The wrapping may be removed entirely before use of the stick. However, a preferred embodiment of this invention employs wrappings which can be readily torn to reveal “fresh” stick. Preferably such wrappings are designed to allow progressive tearing at predetermined points. This may be achieved, for example, by using an excess of wrapping material to generate a flap of wrapping material beyond the line of overlap and fixing. Tear lines or points of weakness are then generated at regular intervals along the flap as starting points for tearing off strips of wrapping. For example, serrations can provide points of weakness, especially in plastic wrappings. Other suitable tear starting points include short cuts and perforated lines in the flap of wrapping material.

Alternatively, the packaging may comprise an applicator made from, for example, plastic or metal. A simple applicator construct may comprise a bottom, in which is held one end of the stick, and a tubular lid, which may partially or fully enclose the insecticidal stick. In order to apply the insecticidal composition, the lid is removed and then replaced after use. More complex applicators enable the insecticidal stick to be extended from a casing. This may be achieved by having the insecticidal stick on a threaded screw and rotating the screw by turning the bottom of the applicator. Alternatively, the stick may be extended from and retracted into a casing by sliding it within the casing. Typically this may be achieved by actuating an arm within a slot in and extending from the casing, the arm being connected to a housing holding the stick within the casing. The art is replete with examples of suitable applicators which may be employed with the insecticidal stick of the present invention. For example, applicators used in personal care for delivery of lipsticks, lipsalves and deodorants, are particularly useful.

The packaging itself can comprise a label or alternatively a label can be applied to the packaging. Suitably, the label includes information on the product, such as the brand name etc., and instructions for use. A major advantage of using a packaging is that it reduces the level of direct human contact with the insecticidal composition. In addition, wrappings tend to increase the strength of the sticks. Packagings in which the sticks are enclosed within rigid casings allow for stick compositions to be used that may not be entirely suitably for use as “crayon-like” products because, for example, they are softer in nature. Preferably, the packaging material is such that it does not allow the insecticidal composition, or components thereof, to leach into or out through it. Suitable wrapping materials in this respect include paper, plastic films (e.g. polypropylene), fabric, metal foil and laminates of these. When using paper or fabric as wrapping materials, it is desirable to coat the side of the wrapping material coming into contact with the insecticidal composition with a suitable protective layer, such as an oil resistant layer. Examples of suitable paper wrappings include wax-coated paper, polymer film coated paper (e.g. milk carton materials) and paper which has been solvent or chemically treated, such as siliconised paper or greaseproof paper.

The sticks can be manufactured using techniques already known in the art. For example, the methods used to manufacture personal care products such as lipsticks and lipsalves can be readily-imported and adapted for the manufacture of the insecticidal sticks of the present invention. Such methods are well-known and described, for example, in Harry's Cosmeticology, (1982), 7^{th} Edition, Longman Scientific & Technical, U.K. In addition, the techniques employed in the manufacture of waxy crayons can also be imported and adapted for the manufacture of the present stick compositions. All of the aforementioned manufacturing processes typically employ melt cast processes in which the formulation is prepared as a molten mixture, poured into moulds, allowed to set and finally removed. Accordingly, the insecticidal sticks of the present invention may be prepared by:

(i) forming a molten, pourable mixture of the insecticidal composition;

(ii) pouring the molten mixture into moulds;

(iii) allowing the mixture to set in the moulds; and

(iv) releasing the solid stick insecticidal compositions from the moulds.

In order to facilitate setting and good surface properties, the moulds may be cooled either prior to and/or during step (iii). This may, for example, be achieved through circulating water, which itself may have been chilled. The moulds are suitably made from metal, for example brass, and are commonly referred to as pipe moulds. The molten composition is poured onto a flatbed moulding table containing multiple holes (often thousands), each hole being suitably shaped to form, for example, a stick with a circular cross section and having a tapered end. As the molten compositions settles into the moulds, it is optionally cooled by circulating water. Once the insecticidal sticks have cooled and solidified, any excess material is scraped away and the sticks are removed from the moulds. Removal may be achieved by pushing rods, which sit at the base of the moulds during the casting process, into the moulds. The sticks may be further shaped once released. For example, they may be shaved or cut into appropriate lengths. The sticks may then go on to be packaged as it appropriate.

It is also possible to produce the insecticidal compositions of the present invention by extrusion techniques.

The insecticidal sticks of the present invention may be used to control any insects which tend to land and/or crawl over hard surfaces such as ants, cockroaches, silverfish, terrestrial crustaceans such as woodlice (slaters), stored product pests, and flies. The insecticidal stick compositions are particularly effective at controlling insects which crawl over hard surfaces and have been found to be particularly effective at controlling the Blattella germanica (German cockroach) and Periplaneta americana (American cockroach).

The invention will now be further illustrated with reference to the following non-limiting examples:

### EXAMPLES

### Example 1

Solid Stick Insecticidal Formulation

Solid stick insecticidal formulation

| Component | Wt % | Function |
|---|---|---|
| Palm Stearine Hydrogenated | 32.865 | Base component/food material |
| Soya bean Oil | 7.455 | Food material/attractant |
| Soya Lecithin | 4.970 | Base component/food material |
| Distilled Monoglyceride | 1.491 | Base component/food material |
| Malt Liquid Extract Ltnd | 12.921 | Food material/attractant |
| Honey Manufacturing Grade | 24.849 | Food material/attractant |
| Soya Flour Full Fat | 13.945 | Base component/food material |
| Chlorpyrifos 99% | 0.353 | Insecticide |
| Chlorpyrifos (MC) (#) | 0.753 | Insecticide |
| Denatonium Benzoate 2.5% | 0.040 | Human taste deterrent |
| Maple Lactone | 0.010 | Food material/attractant |
| Potassium Sorbate | 0.298 | Preservative |
| TBHQ | 0.050 | Anti-oxidant |

# Chlorpyrifos (MC) is a microencapsulated chlorpyrifos, chlorpyrifos being present at 20 wt % of the capsule weight.

Method of Preparation

The formulation given above was prepared as follows:
i) With the temperature set to 70° C. the soy bean oil and palm stearine were added to a mixer and stirred.
ii) Stirring was continued for 20 minutes, the temperature adjusted to 60° C. and the potassium sorbate added.
iii) Stirring was continued until the materials were well blended and temperature was stable at 60° C.
iv) The soy lecithin was preheated to 30° C. and added to the mixture.
v) Stirring was continued until the mixture was well blended and then the distilled monoglyceride was slowly added.
vi) The malt and honey were preheated 30° C. and then slowly added, with the stirrer speed reduced, along with the benatonium benzoate.
vii) The mixture was stirred until well blended
viii) The Tenox TBHQ was added to the mixture and stirring continued until well blended—some needles may still be visible at this stage
ix) The soy flour was slowly added through a sieve and the mixture stirred until no lumps were visible and the mixture was golden yellow and smooth.
x) Both the 99% chlorpyrifos and MC chlorpyrifos and maple lactone were added to the mixture and the mixture mixed until it was uniform.
xi) Mixing was continued at temperature of 57 to 60° C. for 15 minutes
xii) A sample was taken for testing
xiii) The tested mix was then poured into brass crayon moulds and cooled (in this case refrigerated below 0° C.)
xiv) Once hardened (after about 15 minutes) they were pushed out of the brass moulds using a plastic plunger.
xv) The crayons were wrapped in self-adhesive plastic wrappers with one end of wrapper flush with end of the stick, exposing approximately 10 mm of crayon at the other end.
   The temperature of the mixture was never allowed to rise above 65° C. during either the mixing or filling stages.
   Assay

The efficacy of the crayon composition was compared with that of a gel-type cockroach bait composition containing the same active ingredient in the same concentration. The gel-type bait was applied as “blobs” onto the plastic test arenas. The crayon composition was drawn as smears onto the plastic test arenas.
i) 8 mixed age and sex American cockroaches were placed in each of 6 plastic arenas (base area 1,785 cm² and height 19 cm); 100 mixed age and sex German cockroaches were placed in each of 6 plastic arenas (base area 988 cm² and height 11 cm). The arenas were covered with ventilated plastic lids to prevent escape. There were three replicates (arenas) for each of the bait treatments.
ii) The cockroaches were provided with a harbourage in the form of half an up-turned egg carton, a water source and a dog food pellet. The positioning of the harbourage, food and water was the same for each arena.
iii) The cockroaches were allowed to acclimatise overnight and any dead were replaced the next morning.
iv) The compositions to be tested were applied as smears (crayon composition) or blobs (gel-type composition) of approximately 0.5 g to the surface of small plastic trays and the plastic trays placed in the same position in each of the treatment arenas. There were six arenas for each of the two treatments (3 American cockroaches, 3 German cockroaches). The compositions were left in each arena for a further three days.
v) Cockroach mortality was assessed at the end of this period and the mean percentage mortality calculated.

Results

% mortality after 3 days

| Species | Crayon | Gel comparison |
|---|---|---|
| American | 89 | 51 |
| cockroaches | | |
| German cockroaches | 67 | 62 |

It is evident from these results that the composition of the present invention demonstrated a superior efficacy against both species of cockroaches when compared to a conventional gel-type bait composition.

### Example 2

The following solid stick insecticidal formulations were prepared:

Formulation 2a

| Component | Wt % | Function |
|---|---|---|
| Palm Stearine Hydrogenated | 32.965 | Base component/food material |
| Soya bean Oil | 7.455 | Food material/attractant |
| Soya Lecithin | 4.970 | Base component/food material |
| Distilled Monoglyceride | 1.491 | Base component/food material |
| Malt Liquid Extract Ltnd | 12.921 | Food material/attractant |
| Honey Manufacturing Grade | 24.849 | Food material/attractant |
| Soya Flour Full Fat | 13.945 | Base component/Food material |
| Chlorpyrifos 99% | 0.506 | Insecticide |
| Denatonium Benzoate 2.5% | 0.040 | Human taste deterrent |
| Maple Lactone | 0.010 | Food material/attractant |
| Potassium Sorbate | 0.298 | Preservative |
| TBHQ | 0.050 | Anti-oxidant |
| Carmoisine (1.5% w/w soln) | 0.500 | Colorant |

Formulation 2b

| Component | Wt % | Function |
|---|---|---|
| Palm Stearine Hydrogenated | 33.465 | Base component/food material |
| Soya bean Oil | 7.455 | Food material/attractant |
| Soya Lecithin | 4.970 | Base component/food material |
| Distilled Monoglyceride | 1.491 | Base component/food material |
| Malt Liquid Extract Ltnd | 12.921 | Food material/attractant |
| Honey Manufacturing Grade | 24.849 | Food material/attractant |
| Soya Flour Full Fat | 13.945 | Base component/food material |
| Chlorpyrifos 99% | 0.506 | Insecticide |
| Denatonium Benzoate 2.5% | 0.040 | Human taste deterrent |
| Maple Lactone | 0.010 | Food material/attractant |
| Potassium Sorbate | 0.298 | Preservative |
| TBHQ | 0.050 | Anti-oxidant |

Other suitable solid stick insecticidal formulations are:

Formulation 2c

| Component | Wt % | Function |
|---|---|---|
| Palm Stearine Hydrogenated | 33.766-33.961 | Base component/ |
| | | food material |
| Soya bean Oil | 7.455 | Food material/ |
| | | attractant |
| Soya Lecithin | 4.970 | Base component/food |
| Distilled Monoglyceride | 1.491 | Base component/ |
| | | food material |
| Malt Liquid Extract Ltnd | 12.921 | Food material/ |
| | | attractant |
| Honey Manufacturing Grade | 24.849 | Food material/ |
| | | attractant |
| Soya Flour Full Fat | 13.945 | Base component/ |
| | | food material |
| Fipronil 97.5% | 0.010-0.205 | Insecticide |
| Denatonium Benzoate 2.5% | 0.040 | Human taste deterrent |
| Maple Lactone | 0.010 | Food material/ |
| | | attractant |
| Potassium Sorbate | 0.298 | Preservative |
| TBHQ | 0.050 | Anti-oxidant |

Formulation 2d

| Component | Wt % | Function |
|---|---|---|
| Palm Stearine Hydrogenated | 31.930-33.869 | Base component/ |
| | | food material |
| Soya bean Oil | 7.455 | Food material/ |
| | | attractant |
| Soya Lecithin | 4.970 | Base component/ |
| | | food material |
| Distilled Monoglyceride | 1.491 | Base component/ |
| | | food material |
| Malt Liquid Extract Ltnd | 12.921 | Food material/ |
| | | attractant |
| Honey Manufacturing Grade | 24.849 | Food material/ |
| | | attractant |
| Soya Flour Full Fat | 13.945 | Base component/ |
| | | food material |
| Indoxacarb 98% | 0.102-2.041 | Insecticide |
| Denatonium Benzoate 2.5% | 0.040 | Human taste deterrent |
| Maple Lactone | 0.010 | Food material/ |
| | | attractant |
| Potassium Sorbate | 0.298 | Preservative |
| TBHQ | 0.050 | Anti-oxidant |

### Example 3

A solid stick of formulation 2b was prepared according to the method described in Example 1. The crayon had a diameter of 13 mm, a length of 78 mm and weighed 10 g.

For comparative purposes, a stick of the composition described in U.S. Pat. No. 3,162,575 (Lang) was prepared. The Lang stick had the same dimensions as the stick of formula 2b and a similar weight. The stick comprised:

60 wt % microcrystalline wax—made up of a combination of white 1275/7 (ex Frank B Ross) and HiMic 1070 (ex BP Global Special Products) to give a melting point of 71° C. as required by Lang.

20 wt % medium viscosity oil.

20 wt % powdered sucrose.

The hardness of solid stick compositions were determined by penetrometry using a lab plant PNT penetrometer equipped with a Seta wax needle (weight 2.5 grams) and having a cone angle at the point of the needle specified to be 9°10′+/−15′. The barrels of sticks were cut to leave a flat uniform surface. The needle was lowered onto the cut surface and a penetration hardness measurement conducted by allowing the needle with its holder to drop under a total weight, (ie. the combined weight of needle and holder) of 50 grams for a period of five seconds after which the depth of penetration was noted. The test was carried out at six points on the formula 2b stick sample and nine points on the Lang stick sample and the results averaged.

3 runs on the formula 2b stick gave average values of 2.52, 2.55 and 1.98 mm

1 run on the formula 2b stick gave an average value of 2.12 mm

1 run on the Lang stick gave an average value 5.59 mm.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A solid stick insecticidal composition comprising a base, an insecticide and at least 60 wt % food material the composition having a penetration hardness of from 0.1 to 5 mm.

2. The insecticidal composition of claim 1 comprising at least 65, food material.

3. The insecticidal composition of claim 1 comprising 99.99 wt % food material.

4. The insecticidal composition of claim 1 comprising food material selected from
(i) carbohydrates;
(ii) protein/carbohydrate containing materials;
(iii) fatty or oily materials; and mixtures thereof.

5. The insecticidal composition of claim 4, in which the carbohydrates are selected from
(i) honey;
(ii) sugars including monosaccharides and dissaccharides;
(iii) polysaccharides and complex carbohydrates including cellulosic materials, pectin and starches; and mixtures thereof.

6. The insecticidal composition of claim 4, in which the protein/carbohydrate containing materials are selected from:
(i) cereal products,
(ii) flour, including soy flour;
(iii) spices;
(iv) vegetable products including dehydrated vegetables;
(v) dried yeast;
(vi) egg powder;
(vii) insect-derived materials including silkworm pupa, eggs and body pans; and mixtures thereof.

7. The insecticidal composition of claim 4, in which the fatty or oily materials are selected from:
(i) lipids;
(ii) essential oils;
(iii) fully hydrogenated fatty acids;
(iv) vegetable oils;
(v) animal-derived fats;
(vi) esters;
(vii) waxes;
(viii) soaps;
(ix) phospholipids;
(x) glycolipids;
(xi) terpenes;
(xii) steroids; and mixtures thereof.

8. The insecticidal composition of claim 1 comprising at least 10 wt % of a base.

9. The insecticidal composition of claim 1 comprising a base ingredients selected from a fatty alcohol, a fatty acid, an fatty ester including lower alkyl esters of fatty acids, castor oil, mineral oil, petroleum jelly, polyethylene glycol, monoalkanolamide, carnauba wax, candelilla wax, amorphous hydrocarbon wax, petroleum-based wax including microcrystalline wax, beeswax, paraffin wax, cocoa butter, hydrogenated vegetable oil, lanolin, lanolin absorption base, paraffin oil, lecithin, silicone wax, flour, monoglyceride and animal derived-fat including tallow, lard, suet and duck fact, or mixtures thereof.

10. The insecticidal composition of claim 1 comprising one or more dual functionality materials acting as both a food material and a base ingredient.

11. The insecticidal composition of claim 10, in which the dual functionality material is selected from hydrogenated palm oil, tallow, lard, suet, duck fat, fatty acid monoglyceride, flour, lecithins or mixtures thereof.

12. The insecticidal composition of claim 1 in which the base comprises an emulsifying agent or mixtures thereof.

13. The insecticidal composition of claim 1, in which the insecticide is selected from a pyrethroid, a neonicotinoid, an avermectin, a spinosyn, a hydramethylnon, a fluorinated sulfltioramide, an organophosphate, a pyrazole, a chlorfenapyr, a indoxacarb, a borate, a benzoylphenyl urea, a carbamate, a hydrazone and mixtures thereof.

14. The insecticidal composition of claim 13, in which the insecticide comprises an organophosphate.

15. The insecticidal composition of claim 14, in which the organophosphate is chlorpyrifos.

16. The insecticide composition of claim 13, in which the insecticide comprises a pyrazole.

17. The insecticide composition of claim 16, in which the pyrazole is fipronil.

18. The insecticide composition of claim 13, in which the insecticide comprises an indoxacarb.

19. The insecticidal composition of claim 1 comprising the insecticide in an amount of from 0.01 to 40 wt %, preferably from 0.01 to 20 wt % and more preferably from 0.01 to 10 wt % of the insecticide.

20. The insecticidal composition of claim 1 comprising an insect attractant.

21. The insecticidal composition of claim 20, in which the food material also functions as an attractant.

22. The insecticidal composition of claim 21, in which soy bean oil is a food material and an attractant.

23. The insecticidal composition of claim 21, in which honey is a food material and an attractant.

24. The insecticidal composition of claim 21, in which malt extract is a food material and an attractant.

25. The insecticidal composition of claim 21, in which maple lactone is a food material and an attractant.

26. The insecticidal composition of claim 25, in which maple lactone is present in an amount of from 0.001 to 1 wt % of the insecticide composition.

27. The insecticidal composition of claim 20 comprising an attractant which does not function as a food material.

28. The insecticidal composition of claim 1, further comprising a preservative.

29. The insecticidal composition claim 28, in which the preservative is present in an amount of from 0.0001 to 10 wt % of the insecticide composition.

30. The insecticidal composition of claim 28, in which the preservative is selected from sorbic acid and salts thereof, methylparaben, propylparaben and mixtures thereof.

31. The insecticidal composition of claim 1 further comprising an anti-oxidant.

32. The insecticidal composition of claim 31, in which the anti-oxidant is present in an amount of from 0.0001 to 10 wt % of the insecticide composition.

33. The insecticidal composition of claim 31, in which the anti-oxidant is selected from TBHQ, butylated hydroxytoluene, butylated hydroxyanisole and mixtures thereof.

34. The insecticidal composition of claim 1 further comprising a human taste deterrent

35. The insecticidal composition of claim 34, in which the human taste deterrent is present in an amount of from 1 to 200 ppm of the insecticide composition.

36. The insecticidal composition, in which the human taste deterrent is denatonium benzoate.

37. The insecticide composition of claim 1 further comprising a colorant.

38. The insecticidal composition of claim 1 further comprising a component selected from a feeding stimulant, and a filler, and animal taste deterrent of mixtures thereof.

39. The insecticidal composition of claim 1 having a penetration hardness of from 0.5 to 5 mm.

40. The insecticidal composition of claim 39 having a penetration hardness of from 1 to 5 mm.

41. The insecticidal composition of claim 40 having a penetration hardness of from 1 to 4 mm.

42. The insecticidal composition of claim 1 having a melting point of at least 20° C.

43. The insecticidal composition of claim 1 having a setting point in the range from 20 to 200° C.

44. The method for controlling insects in which a solid stick insecticidal composition of claim 1 is applied to deposit the composition onto a hard surface to be treated.

45. The method for controlling insects of claim 44, in which the insecticidal composition is applied to the hard surface as a line of material by drawing the stick along the hard surface.

46. The method for controlling insects of claim 44, in which the insecticidal composition is applied as a series of spots on the hard surface.

47. The method for controlling insects of claim 44, in which the insecticidal composition is applied as an arbitrary smear on the surface.

48. The method for controlling insects of claim 44, in which the insects are crawling insects.

49. The method for controlling insects of claim 48, in which the insects are cockroaches.

50. An insect control product comprising a solid stick insecticidal composition of claim 1 and a package.

51. The insect control product of claim 50 in which the package also comprises a protective wrapping over the package containing the insecticidal composition.

52. The insect control product of claim 51 in which the protective wrapping comprises paper, plastic, fabric, metal foil or a laminate thereof.

53. The insect control product of claim 51, in which the wrapping includes a tear line or point of weakness at a location or one or more intervals along the length of the wrapping thus allowing for progressive removal of circumferential strips of wrapping.

54. The insect control product of claim 50 in which the package comprises an applicator including a bottom, in which is held one end of the stick, and a tubular lid, which at least partially encloses the insecticidal stick.

55. The insect control product of claim 50 in which the package comprises an applicator in which the insecticidal stick is extendable from a casing.

56. The insect control product of claim 50 in which the package or wrapping comprises a label.

57. The insecticidal composition of claim 1 having a melting point of at least 35° C.

58. The insecticidal composition of claim 1 having a melting point of at least 40° C.

59. The insecticidal composition of claim 1 having a melting point of at least 45° C.
